(19) United States
(12) Patent Application Publication
(10) Pub. No.: US 2024/0429435 A1
(43) Pub. Date: Dec. 26, 2024

(54) Composite Particulates for Lithium Batteries

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/340,369

(22) Filed: Jun. 23, 2023

(51) Int. Cl. H01M 10/056; H01M 4/131; H01M 4/133; H01M 4/134; H01M 4/36; H01M 4/505; H01M 4/525; H01M 4/62; H01M 10/0525

(52) U.S. Cl. CPC H01M 10/056; H01M 4/131; H01M 4/133; H01M 4/134; H01M 4/364; H01M 4/366; H01M 4/505; H01M 4/525; H01M 4/623; H01M 10/0525; H01M 2004/021; H01M 2300/0068; H01M 2300/0071

(57) ABSTRACT

Multi-functional composite particulates for a lithium battery, wherein at least one of the composite particulates has a diameter from 100 nm to 50 μm and comprises (a) a polymer electrolyte, comprising from 0.1% to 50% by weight of a lithium salt dissolved or dispersed in the polymer electrolyte; (b) a plurality of primary particles of an anode or cathode active material that are encapsulated by, embedded in, dispersed in, or bonded by the polymer electrolyte having a lithium ion conductivity from 10⁻⁸ to 5×10⁻² S/cm, wherein the primary particles occupy a weight fraction from 5% to 98%; (c) particles of an inorganic material occupying a weight fraction from 0% to 30% (preferably from 0.1% to 20%); and (d) an electron-conducting additive having a weight fraction of 0% to 30% (preferably from 0.1% to 20%) based on the total weight of the composite particulate.

### FIELD

The present disclosure relates generally to the field of lithium-ion or lithium metal batteries and, in particular, to composite particulates for use to build an anode, cathode, and/or solid-state electrolyte separator of a lithium battery.

### BACKGROUND

Rechargeable lithium-ion (Li-ion) and lithium metal batteries (e.g., lithium-lithium metal oxide, lithium-sulfur, lithium-selenium, and Li metal-air batteries) are considered promising power sources for electric vehicle (EV), hybrid electric vehicle (HEV), and portable electronic devices, such as lap-top computers and mobile phones.

A unit cell of a lithium-ion battery is typically composed of an anode current collector, an anode or negative electrode layer (containing an anode active material responsible for storing lithium therein, a conductive additive, and a resin binder), an electrolyte and porous separator, a cathode or positive electrode layer (containing a cathode active material responsible for storing lithium therein, a conductive additive, and a resin binder), and a separate cathode current collector. The electrolyte is in ionic contact with both the anode active material and the cathode active material. A porous separator is not required if the electrolyte is a solid-state electrolyte.

The liquid electrolytes used for current lithium-ion batteries and all lithium metal secondary batteries pose some safety concerns. Most of the organic liquid electrolytes can suffer from thermal runaway or explosion problems.

Solid state electrolytes are commonly believed to be relatively safe in terms of improved resistance to fire and explosion. Solid state electrolytes can be divided into organic (polymeric), inorganic, and organic-inorganic composite electrolytes. However, the conductivity of well-known organic polymer solid state electrolytes, such as poly(ethylene oxide) (PEO), polypropylene oxide (PPO), poly(ethylene glycol) (PEG), and poly(acrylonitrile) (PAN), is typically low (<10⁻⁵ S/cm).

Although the inorganic solid-state electrolyte (e.g., garnet-type and metal sulfide-type) can exhibit a high conductivity (from 0.05×10⁻³ to 10⁻² S/cm), the interfacial impedance or resistance between the inorganic solid-state electrolyte and the electrode (cathode or anode) is high. Further, the traditional inorganic ceramic electrolyte is very brittle and has poor film-forming ability and poor mechanical properties. These materials cannot be cost-effectively manufactured.

Furthermore, the most serious drawback of implementing the inorganic solid electrolyte (ISE) in an electrode (anode or cathode) is the notion that it would normally take a high loading of the ISE particles (typically 30-60% by volume) to meet the two essential conditions: (i) the electrolyte must form a contiguous phase through which lithium ions can travel to reach individual particles of an anode or cathode active material; and (ii) substantially each and every electrode active material particle (e.g., graphite or Si particles in the anode or lithium metal oxide particles in the cathode) must be in physical contact with this contiguous electrolyte phase. This implies that the proportion of the electrode active material responsible for the lithium ion storage capability in an electrode would be reduced to less than 40-70%, leading to a significantly reduced energy density of the resulting battery cell. It is thus essential to minimize the amounts of the electrolyte and other non-active materials, such as conductive filler and binder, in an electrode.

The applicant's research group has previously developed the quasi-solid electrolytes (QSE), which may be considered as a fourth type of solid-state electrolyte. In certain variants of the quasi-solid electrolytes, a small amount of liquid electrolyte may be present to help improving the physical and ionic contact between the electrolyte and the electrode, thus reducing the interfacial resistance. A small proportion of liquid solvent dispersed in a majority of polymer matrix may be referred to as a state of “solvent-in-polymer”. If the liquid solvent forms a continuous phase we have a state of “polymer-in-solvent”. Both are herein referred to as a quasi-solid electrolytes. Examples of QSEs are disclosed in the following: Hui He, et al. “Lithium Secondary Batteries Containing a Non-flammable Quasi-solid Electrolyte.” U.S. patent application Ser. No. 13/986,814 (Jun. 10, 2013); U.S. Pat. No. 9,368,831 (Jun. 14, 2016); U.S. Pat. No. 9,601,803 (Mar. 21, 2017); U.S. Pat. No. 9,601,805 (Mar. 21, 2017); U.S. Pat. No. 9,059,481 (Jun. 16, 2015).

However, the presence of certain liquid electrolytes may cause some problems, such as liquid leakage, gassing, and low resistance to high temperature. Therefore, a novel electrolyte system that obviates all or most of these issues is needed.

Hence, a general object of the present invention is to provide a safe, flame/fire-resistant, quasi-solid or solid-state electrolyte system for a rechargeable lithium cell that is compatible with existing battery production facilities or plastic/composite process and equipment. It is a further object of the present invention to provide a strategy for more effectively using a solid electrolyte that occupies a minimal proportion of the total volume of an electrode, yet still forms a contiguous phase in the electrode and is in physical contact with substantially all the electrode active material particles.

### SUMMARY

The present disclosure provides multi-functional composite particulates for a lithium battery, wherein at least one of the composite particulates has a diameter from 100 nm to 50 μm (preferably from 1 to 20 μm) and comprises (a) a polymer electrolyte, comprising from 0% to 50% (preferably from 0.1% to 40%, further preferably 1% to 30%) by weight of a lithium salt dissolved or dispersed in the polymer electrolyte; (b) a plurality of primary particles of an anode or cathode active material that are embedded or dispersed in or bonded by the polymer electrolyte, wherein the polymer electrolyte has a lithium ion conductivity from 10⁻⁸ to 5×10⁻² S/cm and wherein the active material primary particles have a diameter or thickness from 1 nm to 30 μm (preferably from 100 nm to 10 μm) and occupy a weight fraction from 5% to 98% (preferably from 30% to 95%) based on the total weight of the composite particulate; (c) particles of an inorganic material having a diameter or thickness from 2 nm to 10 μm and occupying a weight fraction from 0% to 30% (preferably from 0.1% to 20%) based on the total weight of the composite particulate; and (d) an electron-conducting additive (e.g., carbon nanotubes, graphene sheets, graphite particles, carbon black, etc.) having a weight fraction of 0% to 30% (preferably from 0.1% to 20%) based on the total weight of the composite particulate.

These multi-functional composite particulates serve as a building block for building up an anode (negative electrode) or cathode (positive electrode). During such an electrode making process, substantially no organic solvent is involved and, hence, no solvent removal procedure is needed, which otherwise requires a long (50-120 meters in length) chain of ovens. Further importantly, the essential ingredients of an electrode (such as an active material, lithium salt, solid electrolyte, and electron-conducting additive) are already homogeneously mixed and dispersed in individual composite particulates. When combined and merged together, these composite particulates lead to an electrode having a high proportion of active material and a contiguous or continuous electrolyte phase.

The disclosure also provides another kind of multi-functional composite particulates for a lithium battery, wherein at least one of the composite particulates has a diameter from 100 nm to 50 μm and comprises (A) a polymer electrolyte, comprising from 0.1% to 50% by weight of a lithium salt dissolved or dispersed in said polymer electrolyte having a lithium ion conductivity from 10⁻⁸ to 5×10⁻² S/cm; and (B) particles of an inorganic material having a diameter or thickness from 2 nm to 10 μm and occupying a weight fraction from 1% to 98% (preferably from 30% to 95%) based on the total weight of the composite particulate. No anode or cathode active material and no electron-conducting additive is included in the composite particulate. These particulates are particularly useful for building up a solid-state electrolyte-based separator. They can also be included in the anode or cathode to improve the ion conductivity of the resulting anolyte or catholyte. The present disclosure also provides a powder mass comprising these multi-functional composite particulates.

In all the aforementioned embodiments, preferred examples of the polymer electrolyte include poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer (e.g., those with a carboxylate anion, a sulfonylimide anion, or sulfonate anion), poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof.

It may be noted that the polymers in the above list are commonly used as an ingredient in a gel polymer electrolyte or solid polymer electrolyte of a lithium-ion battery cell. These polymers, however, have not been previously used in a composite particulate as herein disclosed that serves as a building block for an anode, cathode, or separator.

The lithium salt is preferably selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂) 2, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl) imide, lithium bis(fluorosulphonyl) imide, lithium trifluoromethanesulfonimide, LiTFSI, an ionic liquid-based lithium salt, or a combination thereof.

In the multi-functional composite particulates, the polymer electrolyte may be further impregnated with an organic liquid solvent, an ionic liquid, or a combination thereof. Such a liquid may be pre-impregnated into the electrolyte polymer during or after the composite particulates are made, but prior to being incorporated in the anode electrode and the fabrication of the battery cell. However, in certain embodiments, the liquid solvent or ionic liquid may permeate into the polymer of the particulate from the liquid electrolyte that is injected into an electrode or into the cell after the cell is made.

In some embodiments, the polymer electrolyte comprises (i) a polymer that is meltable by heat or soluble by a liquid solvent; or (ii) a precursor, comprising a monomer with an initiator and/or a cross-linking agent, an oligomer, or a growing chain that is polymerizable, cross-linkable, partially polymerized, or partially cross-linked. A meltable polymer is one that, when heated above a glass transition temperature or melting point, can flow to merge with the same or a different polymer. This feature allows multiple composite particulates to be combined, compacted, melted, and consolidated together to form an electrode. The soluble polymer is capable of merging with each other if the composite particulate surface is wetted with a liquid solvent (organic or ionic liquid). The partially polymerized or partially cross-linked, essentially a living polymer, is also capable of merging with each other from different composite particulates when being consolidated.

The composite particulate may be further encapsulated by a shell of a conducting material selected from a graphene, carbon (e.g. amorphous carbon, CVD carbon, PVD carbon, sputtering carbon, polymeric carbon, carbon nano particles, carbon black, acetylene black, carbon nanotube, carbon nano-fiber, etc.), graphite (e.g. expanded graphene flakes, exfoliated graphite worms, nano-scaled or sub-micron-scaled graphite particles), conducting polymer, metal, composite, or a combination thereof. Preferably, the shell has an electrical conductivity from 10⁻⁸ S/cm to 10³ S/cm, more preferably from 10⁵ S/cm to 10² S/cm and further preferably at least 10⁻² S/cm. The shell preferably has a thickness from 0.34 nm (thickness of a pristine graphene) to 10 μm (preferably less than 1 μm).

In some embodiments, the composite further comprises graphene sheets (inside the particulate as a conductive additive) selected from pristine graphene, graphene oxide, reduced graphene oxide, graphene fluoride, graphene chloride, graphene bromide, graphene iodide, nitrogenated graphene, hydrogenated graphene, doped graphene, chemically functionalized graphene, or a combination thereof.

In some embodiments, the polymer electrolyte further comprises a conductive additive selected from carbon nanotubes, carbon nano-fibers, carbon or graphite fibers, graphene sheets, expanded graphite flakes, metal filaments or metal nano-wires, whiskers, carbon black, acetylene black, needle coke, carbon particles, graphite particles, or a combination thereof. The polymer electrolyte may further comprise a reinforcement material, such as polymer fibrils, glass fibers, ceramic fibers, or a combination. The preferred amount of the conductive additive or reinforcement material is from 1% to 30% by weight based on the total composite particulate weight.

The anode active material may be selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide; (f) prelithiated versions thereof; (g) particles of Li, Li alloy, or surface-stabilized Li having at least 60% by weight of lithium element therein; and (h) combinations thereof. The Li alloy may contain from 0.1% to 10% by weight of a metal element selected from Zn, Ag, Au, Mg, Ni, Ti, Fe, Co, V, Al, or a combination thereof.

The anode active material may contain a prelithiated Si, prelithiated Ge, prelithiated Sn, prelithiated SnOₓ, prelithiated SiOₓ, prelithiated iron oxide, prelithiated Mn₃O₄, prelithiated Co₃O₄, prelithiated Ni₃O₄, lithium titanate, lithium niobite, or a combination thereof, wherein x=1 to 2.

The cathode active material may be selected from an inorganic material, an organic material, a polymeric material, or a combination thereof. The inorganic material, as a cathode active material, may be selected from sulfur, selenium, a metal oxide, metal phosphate, metal silicide, metal selenide, metal sulfide, or a combination thereof.

In some embodiments, the inorganic cathode active material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof. For instance, the inorganic cathode active material may be selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V. Ti, Al, B, Sn, or Bi; and x+y≤1.

The metal oxide or metal phosphate, as a cathode active material, may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals. The cathode active material may comprise lithium nickel manganese oxide (LiNiₐMn₂₋ₐO₄, 0<a<2), lithium nickel manganese cobalt oxide (LiNiₙMnₘCO₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCO₁₋ₚO₂, 0<p<1), or lithium nickel manganese oxide (LiNi_{q}Mn_{2-q}O₄, 0<q<2).

The primary particles of anode or cathode active material may be in a form of nano particle, nano wire, nano fiber, nano tube, nano sheet, nano belt, nano ribbon, nano disc, nano platelet, or nano horn having a thickness or diameter from 0.5 nm to 100 nm. In some embodiments, at least one of the primary anode active material particles is coated with a layer of carbon, graphite, or graphene.

In some preferred embodiments, the particles of inorganic material dispersed in the polymer electrolyte matrix comprise particles of an inorganic solid electrolyte material selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof. The particles of inorganic material may be selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂. Li₂S, LiₓSO_{y}, or a combination thereof, wherein X=F, Cl, I, or Br, R=a hydrocarbon group, x=0-1, y=1-4.

The present disclosure also provides a powder mass comprising the multi-functional composite particulates, wherein the particulates comprise primary particles of an anode active material. Also provided is a powder mass comprising the multi-functional composite particulates, wherein the particulates comprise primary particles of a cathode active material.

The disclosure further provides a battery anode or negative electrode that comprises the disclosed multi-functional composite particulates as an anode material or is made from the multi-functional composite particulates. The disclosure also provides a battery cathode or positive electrode that comprises the multi-functional composite particulates as a cathode material or is made from the multi-functional composite particulates.

The disclosure provides a battery comprising the multi-functional composite particulates as an anode material or a cathode material, wherein the battery is a lithium-ion battery, lithium metal battery, lithium-sulfur battery, lithium-air battery, or lithium-selenium battery.

The present disclosure also provides a method of producing the aforementioned battery, comprising (a) dispensing and consolidating a plurality of the multi-functional composite particulates into a cathode film on at least a surface (preferably two surfaces) of a first solid substrate to form a cathode (positive electrode); (b) providing an anode (negative electrode); (c) providing a separator (e.g., a solid-state electrolyte layer); and (d) combining or laminating the cathode, the separator, and the anode into a battery cell and optionally enclosing the cell in a protective housing.

In certain embodiments, step (b) comprises dispensing and consolidating a plurality of the multi-functional composite particulates into an anode film on at least a surface (preferably two surfaces) of a second solid substrate to form an anode.

In some embodiments, step (a) comprises (a-1) electrically charging the plurality of multi-functional composite particulates onto at least a surface of the first solid substrate and heating and compressing the composite particulates against the first solid substrate to form a cathode; or comprises (a-2) heating, extruding, and compressing the composite particulates into a cathode film which is supported on a surface of the first solid substrate.

In some preferred embodiments, step (b) comprises (b-1) electrically charging the plurality of multi-functional composite particulates onto at least a surface of the second solid substrate and heating and compressing the composite particulates against the second solid substrate to form an anode; or comprises (b-2) heating, extruding, and compressing the composite particulates into an anode film which is supported on a surface of the second solid substrate.

In some embodiments, step (c) of providing a separator comprises preparing a separator layer comprising (i) a polymer electrolyte comprising from 0.1% to 50% by weight of a lithium salt dissolved or dispersed in said polymer electrolyte, wherein said polymer electrolyte has a lithium ion conductivity from 10⁻⁸ to 5×10⁻² S/cm; and (ii) particles of an inorganic material having a diameter or thickness from 2 nm to 10 μm and occupying a weight fraction from 0% to 99% (preferably from 60% to 95%) based on the total weight of the separator layer.

In some preferred embodiments, step (c) of providing a separator comprises a sub-step (c-1) of preparing a plurality of composite particulates wherein at lease a composite particulate comprises (i) a polymer electrolyte comprising from 0.1% to 50% by weight of a lithium salt dissolved or dispersed in the polymer electrolyte having a lithium ion conductivity from 10⁻⁸ to 5×10⁻² S/cm; and (ii) particles of an inorganic material having a diameter or thickness from 2 nm to 10 μm and occupying a weight fraction from 0% to 99% (preferably from 60% to 95%) based on the total weight of the composite particulate; and a sub-step (c-2) of forming the plurality of composite particulates into a separator layer.

The disclosure further provides a method of producing the aforementioned battery, the method comprising (a) dispensing and consolidating a plurality of the multi-functional composite particulates into an anode film on at least a surface of a first solid substrate to form an anode; (b) providing a cathode; (c) providing a separator; and (d) combining or laminating the cathode, the separator, and the anode into a battery cell and optionally enclosing the cell in a protective housing.

In all the aforementioned embodiments, the anode, the separator, or both the anode and the separator may preferentially comprise a polymer electrolyte that is substantially the same type of polymer as in the cathode or chemically compatible with the polymer in the cathode.

The disclosure also provides a method of producing the disclosed multi-functional composite particulates, the method comprising (A) dispersing (i) a plurality of primary particles of an anode active material or cathode active material (having a diameter or thickness from 0.5 nm to 20 μm), (ii) a lithium salt, and (iii) particles of an inorganic solid electrolyte (having a diameter or thickness from 2 nm to 20 μm) in a liquid mixture of a monomer or oligomer, an initiator, and/or a cross-linking agent to form a reactive slurry; (B) forming the reactive slurry into micro-droplets and partially polymerizing and/or curing the monomer or oligomer in the micro-droplets to form the multi-functional particulates.

Also provided is a method of producing the multi-functional composite particulates, the method comprising (A) dispersing (i) a plurality of primary particles of an anode active material or cathode active material (having a diameter or thickness from 0.5 nm to 20 μm), (ii) a lithium salt, and (iii) particles of an inorganic solid electrolyte (having a diameter or thickness from 2 nm to 20 μm) in a polymer solution (containing a polymer dissolved in a liquid solvent) to form a slurry; (B) forming the slurry into micro-droplets and removing the liquid solvent in the micro-droplets to form the multi-functional particulates. In some embodiments, the reactive slurry further comprises a reinforcement material, an electron-conducting additive, or a combination thereof.

The intended polymer electrolyte may be selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof.

In some embodiments, step (B) of forming micro-droplets comprises a procedure selected from pan-coating, air-suspension coating, centrifugal extrusion, vibration-nozzle encapsulation, spray-drying, coacervation-phase separation, interfacial polycondensation or interfacial cross-linking, in-situ polymerization, matrix polymerization, extrusion and palletization, or a combination thereof. In certain preferred embodiments, step (B) comprises conducting spray-drying, fluidized bed coating, or air-suspension coating to produce the multi-functional particulates.

The reinforcement material or ion-conducting additive may be selected from carbon nanotubes, carbon nano-fibers, carbon or graphite fibers, graphene sheets, expanded graphite flakes, carbon black, acetylene black, polymeric carbon, polymer fibrils, glass fibers, ceramic fibers, metal filaments, metal nano-wires, or a combination thereof.

In some embodiments, the precursor liquid may contain a monomer, an initiator or catalyst, a crosslinking agent, an oxidizer and/or dopant. During or after the micro-droplet formation procedure, one may initiate the polymerization and/or crosslinking reactions to produce linear-chain polymer, branched chain polymer, or a cross-linked network of polymer chains in the droplets. In the particulate, the primary particles of an active material, particles of an inorganic solid electrolyte, an ion-conducting additive, and some optional reinforcement materials, are embedded in or encapsulated by the electrolyte polymer chains.

The anode active material is preferably in a form of nano particle, nano wire, nano fiber, nano tube, nano sheet, nano belt, nano ribbon, nano disc, nano platelet, or nano horn having a thickness or diameter from 0.5 nm to 100 nm.

In some embodiments, the particles of anode active material contain pre-lithiated particles. In other words, before the electrode active material particles (such as Si or SnO₂) are combined with a sacrificial material and embraced by graphene sheets, these particles have been previously intercalated with Li ions (e.g. via electrochemical charging) up to an amount of 0.1% to 30% by weight of Li. Such a pre-lithiating step may be conducted after the porous anode particulates are made.

In some embodiments, the primary particles of anode active material contain particles pre-coated with a coating layer of a conductive material selected from carbon, pitch, carbonized resin, a conductive polymer, a conductive organic material, a metal coating, a metal oxide shell, graphene sheets, or a combination thereof. The coating layer thickness is preferably in the range from 1 nm to 20 μm, preferably from 5 nm to 10 μm, and further preferably from 10 nm to 1 μm.

### BRIEF DESCRIPTION OF THE DRAWINGS

FIG. 1(A) A flow chart showing the process for producing multi-functional composite particulates according to certain embodiments of the present disclosure;

FIG. 1(B) A flow chart showing the process for producing multi-functional composite particulates according to some embodiments of the present disclosure.

FIG. 2(A) Schematic illustrating multi-functional composite particulate (as a building block for an anode or cathode) according to certain embodiments of the present disclosure;

FIG. 2(B) Schematic illustrating multi-functional composite particulate (as a building block for a solid-state electrolyte/separator) according to certain embodiments of the present disclosure;

FIG. 2(C) SEM image of composite particulates as a building block for an anode;

FIG. 2(D) SEM image of composite particulates as a building block for a cathode;

FIG. 2(E) SEM image of composite particulates as a building block for a solid-state electrolyte separator.

FIG. 3(A) Schematic illustrating a plurality of multi-functional composite particulates can be combined and consolidated (e.g., by heat or by polymer dissolution on surfaces of particulates, followed by solidification) to form an anode or cathode according to certain embodiments of the present disclosure;

FIG. 3(B) Schematic illustrating a plurality of multi-functional composite particulates can be combined and consolidated (e.g., by heat or by polymer dissolution on surfaces of particulates, followed by solidification) to form a solid-state electrolyte-based separator between an anode and a cathode, according to certain embodiments of the present disclosure.

FIG. 4 Schematic of a lithium battery cell comprising an anode layer (preferably made from combining and consolidating multiple composite particulates herein disclosed), an anode current collector, a separator (preferably made from combining and consolidating multiple composite particulates herein disclosed), a cathode layer (preferably made from combining and consolidating multiple composite particulates herein disclosed), and a cathode current collector (e.g., an Al foil), according certain embodiments of the present disclosure.

FIG. 5 Schematic illustrating a process for producing an electrode (anode or cathode) and a multi-layer structure for a battery cell.

### DETAILED DESCRIPTION

A lithium-ion battery cell is typically composed of an anode current collector (e.g., Cu foil), an anode or negative electrode active material layer (i.e., anode layer typically containing particles of an anode active material, conductive additive, and binder), a porous separator with an electrolyte component (or a solid-state electrolyte also serving as a separator layer), a cathode or positive electrode active material layer (containing a cathode active material, conductive additive, and resin binder), and a cathode current collector (e.g. Al foil). More specifically, the anode layer is composed of particles of an anode active material (e.g. graphite, Sn, SnO₂, or Si), a conductive additive (e.g. carbon black particles), and a resin binder (e.g. SBR or PVDF). This anode layer is typically 50-300 μm thick (more typically 100-200 μm) to give rise to a sufficient amount of current per unit electrode area.

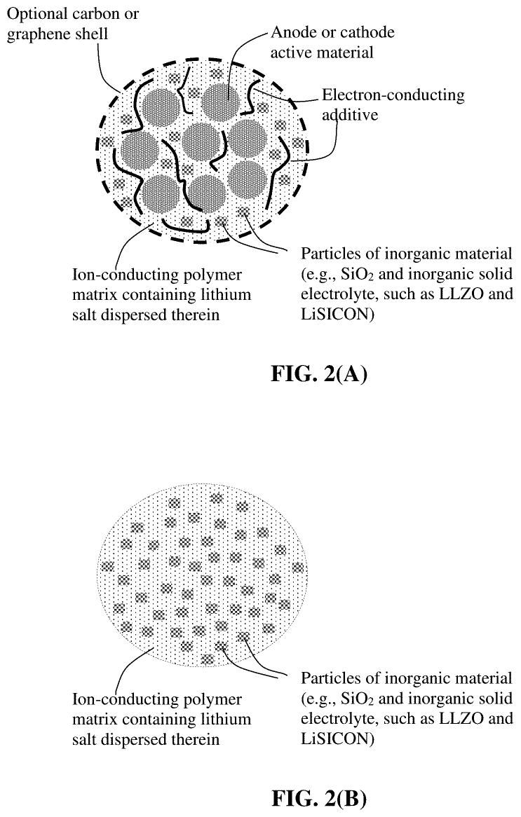

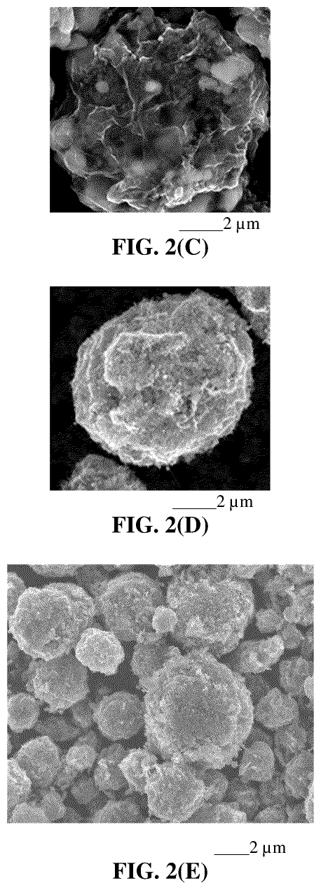

The present disclosure provides multi-functional composite particulates (as illustrated in FIG. 2(A)) for a lithium battery, wherein at least one of the composite particulates has a diameter from 100 nm to 50 μm (preferably from 1 to 20 μm) and comprises (a) a polymer electrolyte, comprising from 0% to 50% (preferably from 0.1% to 40%, further preferably 1% to 30%) by weight of a lithium salt dissolved or dispersed in the polymer electrolyte; (b) a plurality of primary particles of an anode or cathode active material that are embedded or dispersed in or bonded by the polymer electrolyte, wherein the polymer electrolyte has a lithium ion conductivity from 10⁻⁸ to 5×10⁻² S/cm and wherein the active material primary particles have a diameter or thickness from 1 nm to 30 μm (preferably from 100 nm to 10 μm) and occupy a weight fraction from 5% to 98% (preferably from 30% to 95%) based on the total weight of the composite particulate; (c) particles of an inorganic material having a diameter or thickness from 2 nm to 10 μm and occupying a weight fraction from 0% to 30% (preferably from 0.1% to 20%) based on the total weight of the composite particulate; and (d) an electron-conducting additive (e.g., carbon nanotubes, graphene sheets, graphite particles, carbon black, etc.) having a weight fraction of 0% to 30% (preferably from 0.1% to 20%) based on the total weight of the composite particulate. Representative scanning electron microscopy (SEM) images for the anode and cathode application are shown in FIG. 2(C) and FIG. 2(D), respectively.

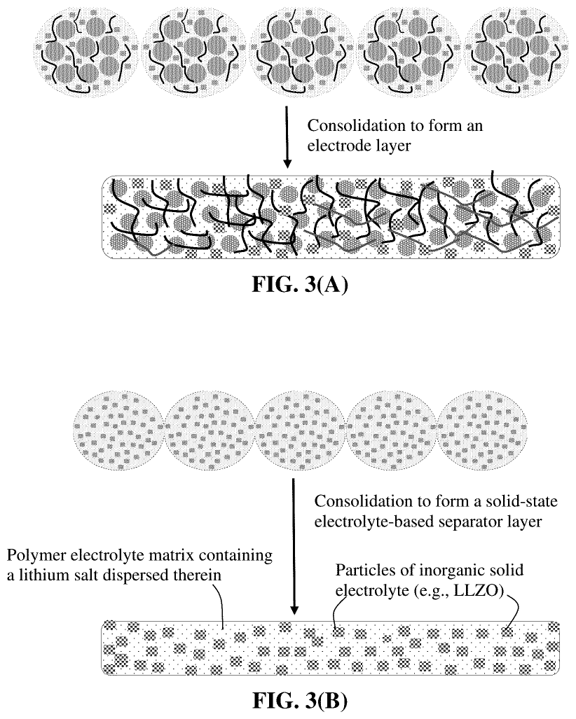

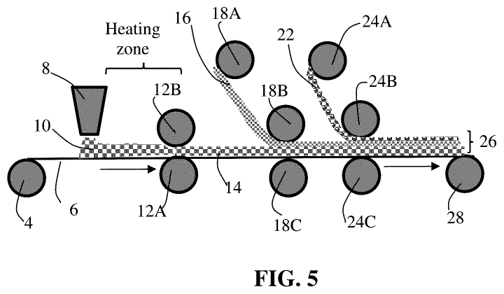

These multi-functional composite particulates serve as a building block for building up an anode (negative electrode) or cathode (positive electrode) through a combination and consolidation procedure, as illustrated in FIG. 3(A). In a preferred embodiment of the instant disclosure, one may simply dispense a powder mass of these multi-functional composite particulates into a primary surface or two primary surfaces of a solid substrate (e.g., an Al foil or Cu foil), followed by heating (slightly above the glass transition or melting point of the polymer), roll-pressing, and cooling to room temperature. This is schematically illustrated in FIG. 5, which shall be further discussed in a later section. During such an electrode making process, substantially no organic solvent is involved and, hence, no significant solvent removal procedure is needed, in contrast to the current lithium-ion cell production process which requires a long chain of ovens (typically 50-120 meters in length).

Further importantly, the essential ingredients of an electrode (such as an active material, lithium salt, solid electrolyte, and electron-conducting additive) are already homogeneously mixed and dispersed in individual composite particulates. When combined and merged together, these composite particulates lead to an electrode having a high proportion of active material and a contiguous or continuous electrolyte phase.

The notion that these composite particulates have already combined and included all the essential ingredients of an electrode in a desired proportion allows the use of plastic or composite processing processes to manufacture the battery electrode layers at scale. These processes (e.g., compression molding, extrusion, casting, roll-pressing, and lamination) are highly scalable and equipment is readily available, as opposed to the current state-of-the-art solid-state battery processes that require complex and new-type of equipment that must be custom-designed and custom-made (hence, expensive and needing a long time-to-market).

The disclosure also provides another kind of multi-functional composite particulates (schematically illustrated in FIG. 2(B)) for a lithium battery, wherein at least one of the composite particulates has a diameter from 100 nm to 50 μm and comprises (A) a polymer electrolyte, comprising from 0.1% to 50% by weight of a lithium salt dissolved or dispersed in said polymer electrolyte having a lithium ion conductivity from 10⁻⁸ to 5×10⁻² S/cm; and (B) particles of an inorganic material having a diameter or thickness from 2 nm to 10 μm and occupying a weight fraction from 1% to 98% (preferably from 30% to 95%) based on the total weight of the composite particulate. No anode or cathode active material and no electron-conducting additive are included in the composite particulate. These particulates are particularly useful for building up a solid-state electrolyte-based separator (e.g., schematically illustrated in FIG. 3(B)). Again, these composite particulates are conducive to fabrication of solid-state electrolyte separator using highly scalable processes, such as compression molding, extrusion, casting, roll-pressing, and lamination. An SEM image for these composite particulates is shown in FIG. 2(E).

Furthermore, these composite particulates can also be included in the anode or cathode to improve the ion conductivity of the resulting anolyte or catholyte. The present disclosure also provides a powder mass comprising these multi-functional composite particulates.

In all the aforementioned embodiments, preferred examples of the polymer electrolyte include poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof.

It may be noted that the polymers in the above list are commonly used as an ingredient in a gel polymer electrolyte or solid polymer electrolyte of a lithium-ion battery cell. These polymers, however, have not been previously used in a composite particulate as herein disclosed that serves as a building block for an anode, cathode, or separator.

In the multi-functional composite particulates, the polymer electrolyte may be further impregnated with an organic liquid solvent, an ionic liquid, or a combination thereof, if so desired. Such a liquid may be pre-impregnated into the electrolyte polymer during or after the composite particulates are made, but prior to being incorporated in the anode electrode and the fabrication of the battery cell. However, in certain embodiments, the liquid solvent or ionic liquid may permeate into the polymer of the particulate from the liquid electrolyte that is injected into an electrode or into the cell after the cell is made.

In some embodiments, the polymer electrolyte comprises (i) a polymer that is meltable by heat or soluble by a liquid solvent; or (ii) a precursor, comprising a monomer with an initiator and/or a cross-linking agent, an oligomer, or a growing chain that is polymerizable, cross-linkable, partially polymerized, or partially cross-linked. A meltable polymer is one that, when heated above a glass transition temperature or melting point, can flow to merge with the same or a different polymer. This feature allows multiple composite particulates to be combined, compacted, melted, and consolidated together to form an electrode. The soluble polymer is capable of merging with each other if the composite particulate surface is wetted with a liquid solvent (organic or ionic liquid). An ionic liquid or flame-resistant organic solvent is preferred. The partially polymerized or partially cross-linked, essentially a living polymer, is also capable of merging with each other from different composite particulates when being consolidated.

The lithium salt dispersed or dissolved in the polymer electrolyte is preferably selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂) 2, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl) imide, lithium trifluoromethanesulfonimide, LiTFSI, an ionic liquid-based lithium salt, or a combination thereof.

The composite particulate may be further encapsulated by a shell of conducting material selected from a graphene, carbon (e.g. amorphous carbon, CVD carbon, PVD carbon, sputtering carbon, polymeric carbon, carbon nano particles, carbon black, acetylene black, carbon nanotube, carbon nano-fiber, etc.), graphite (e.g. expanded graphene flakes, exfoliated graphite worms, nano-scaled or sub-micron-scaled graphite particles), conducting polymer, metal, composite, or a combination thereof. Preferably, the shell has an electrical conductivity from 10⁻⁸ S/cm to 10³ S/cm, more preferably at least 10⁻² S/cm and further preferably at least 10 S/cm.

In some embodiments, the composite further comprises graphene sheets (dispersed therein) wherein graphene sheets are selected from pristine graphene, graphene fluoride, graphene chloride, graphene bromide, graphene iodide, nitrogenated graphene, hydrogenated graphene, doped graphene, chemically functionalized graphene, a combination thereof, or a combination thereof with graphene oxide or reduced graphene oxide. Typically, these graphene sheets, along with the primary anode active material particles, are dispersed in the matrix of electrically and ionically conducting networks of cross-linked polymer chains. These graphene sheets may be located in the encapsulating shell to embrace the composite droplets and/or be part of the droplets.

In some embodiments, the composite particulates further comprises a conductive additive and/or a reinforcement material selected from carbon nanotubes, carbon nano-fibers, carbon or graphite fibers, graphene sheets, expanded graphite flakes, carbon black, acetylene black, polymer fibrils, glass fibers, ceramic fibers, metal filaments or metal nano-wires, whiskers, carbon black, acetylene black, needle coke, carbon particles, graphite particles, or a combination thereof. The preferred amount of the reinforcement material or additive is from 1% to 30% by weight based on the total composite particulate weight. Electrically conductive reinforcements are preferred.

The anode active material may be in a form of minute solid or porous particles (primary anode material particles) having a diameter or thickness preferably from 0.5 nm to 2 μm (further preferably from 1 nm to 100 nm). One or a plurality of primary particles are embedded in, encapsulated by, or bonded by an electrolyte polymer to form a micro-droplet. This micro-droplet is may be further encapsulated or embraced by a shell of a conducting material.

Preferably, the anode active material is a high-capacity anode active material having a specific lithium storage capacity greater than 372 mAh/g, which is the theoretical capacity of lithium storage in graphite. The primary particles themselves may be porous having porosity in the form of surface pores and/or internal pores. These pores of the primary particles allow the particle to expand into the free space without a significant overall volume increase of the particulate and without inducing any significant volume expansion of the entire anode electrode.

The anode active material may be selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide; (f) prelithiated versions thereof; (g) particles of Li, Li alloy, or surface-stabilized Li having at least 60% by weight of lithium element therein; and (h) combinations thereof. The Li alloy may contain from 0.1% to 10% by weight of a metal element selected from Zn, Ag, Au, Mg, Ni, Ti, Fe, Co, V, Al, or a combination thereof.

The anode active material may contain a prelithiated Si, prelithiated Ge, prelithiated Sn, prelithiated SnOₓ, prelithiated SiOₓ, prelithiated iron oxide, prelithiated Mn₃O₄, prelithiated Co₃O₄, prelithiated Ni₃O₄, lithium titanate, lithium niobite, or a combination thereof, wherein x=1 to 2.

The cathode active material may be selected from an inorganic material, an organic material, a polymeric material, or a combination thereof. The inorganic material, as a cathode active material, may be selected from sulfur, selenium, a metal oxide, metal phosphate, metal silicide, metal selenide, metal sulfide, or a combination thereof.

In some embodiments, the inorganic cathode active material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof. For instance, the inorganic cathode active material may be selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

The metal oxide or metal phosphate, as a cathode active material, may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals. The cathode active material may comprise lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

The inorganic solid electrolyte material may be selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

The inorganic solid electrolyte particles that can be incorporated into the hybrid electrolyte include, but are not limited to, perovskite-type. NASICON-type, garnet-type and sulfide-type materials. A representative perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid-state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃ (M=Al, Cr, Ga, Fe, Sc. In, Lu, Y or La), Al substitution has been demonstrated to be the most effective solid-state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a broad series of garnet-type materials may be used as an additive, including Li₅La₃M₂O₁₂ (M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good lithium-ion conductivity close to 10⁻² S/cm. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer as herein disclosed.

These inorganic solid electrolyte (ISE) particles encapsulated by an elastic electrolyte polymer shell can help enhance the lithium ion conductivity of certain polymers that have a lower ion conductivity than the encapsulated SEI. Preferably and typically, the elastic polymer electrolyte has a lithium ion conductivity no less than 10⁻⁵ S/cm, more desirably no less than 10⁻⁴ S/cm, further preferably no less than 10³ S/cm, and most preferably no less than 10⁻² S/cm.

It should be noted that certain inorganic solid electrolytes (e.g., sulfide type ISE) can have a higher lithium-ion conductivity as compared to certain selected polymers. However, sulfide type ISEs are air-sensitive and air-sensitive and, hence, cannot be combined with an anode active material (e.g., graphite or Si) to form an anode using water as a liquid medium in a commonly used slurry coating process. Furthermore, sulfide-type ISEs have a very narrow electrochemical stability window (e.g., from 1.8-2.5 V relative to Li/Li⁺), making them unsuitable for use in the anode, where lithium ion intercalation occurs at approximately 0.23 V for graphite and 0.5 V for Si (significantly lower than 1.8 V). They are also unsuitable for the cathode since the cathode active material typically operates at 3.2-4.4 V for lithium iron phosphate and all lithium transition metal oxides. We have solved this problem by encapsulating the ISE particles with a polymer electrolyte that typically has a significantly wider electrochemical stability window (e.g., can be from 0 to 4.5 V relative to Li/Li⁺). The polymer protection also enables the ISEs processible using the current lithium-ion cell production processes.

The present disclosure also provides a powder mass comprising the multi-functional composite particulates, wherein the particulates comprise primary particles of an anode active material along with other essential ingredients (e.g., lithium salt, particles of solid-state electrolyte, electro-conducting additive, reinforcement, etc.). Also provided is a powder mass comprising the multi-functional composite particulates, wherein the particulates comprise primary particles of a cathode active material along with other essential ingredients.

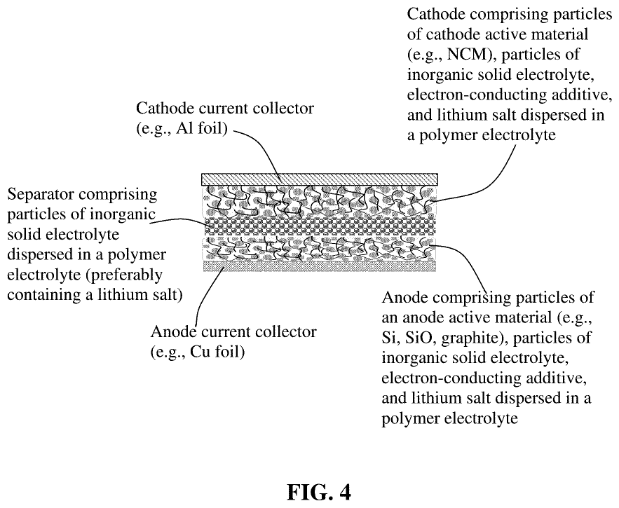

The disclosure further provides a battery anode or negative electrode that comprises the disclosed multi-functional composite particulates as an anode material or is made from the multi-functional composite particulates. This is schematically illustrated in FIG. 4 (lower portion). The disclosure also provides a battery cathode or positive electrode that comprises the multi-functional composite particulates as a cathode material or is made from the multi-functional composite particulates. This is schematically illustrated in FIG. 4 (upper portion).

The disclosure provides a battery (e.g., schematically illustrated in FIG. 4) comprising the multi-functional composite particulates as an anode material or a cathode material, wherein the battery is a lithium-ion battery, lithium metal battery, lithium-sulfur battery, lithium-air battery, or lithium-selenium battery.

The present disclosure also provides a method of producing the aforementioned battery, comprising (a) dispensing and consolidating a plurality of the multi-functional composite particulates into a cathode film on at least a surface (preferably two surfaces) of a first solid substrate to form a cathode (positive electrode); (b) providing an anode (negative electrode); (c) providing a separator (e.g., a solid-state electrolyte layer); and (d) combining or laminating the cathode, the separator, and the anode into a battery cell and optionally enclosing the cell in a protective housing. In some preferred embodiments, the process can be conducted in a roll-to-roll manner.

For instance, as schematically illustrated in FIG. 5, the process may begin with unwinding and feeding a solid substrate film 6 (e.g., an Al foil or Cu foil, or a plastic film) from a feeder roller 4; the solid substrate film is driven to move to the right of the figure. A powder dispenser 8 is operated to continuously or intermittently dispense powder 10 of the multi-functional composite particulates onto a surface of the solid substrate film 6. The powder may be pre-heated or heated between the dispenser 8 and a pair of rollers, 12A, 12B, and roll-pressed by the rollers to form into a solid electrode film 14 (as illustrated in FIG. 3(A)). In certain embodiments of the instant disclosure, this solid electrode film 14 (e.g., a cathode or positive electrode), supported on and bonded to a solid substrate film 6 (e.g., Al foil), may be collected by a collector or winding roller 28 in a roll form. This roll of cathode may be later unwound from the collector roller and cut and trimmed into pieces of cathode of desired shape and sizes. Rolls of anode electrode and rolls of solid-state electrolyte-based separator may be made from respective composite particulates in a similar manner. A piece of cathode, a separator, and an anode may then be combined into a battery cell.

In certain other embodiments, the solid electrode film 14 (e.g., as a cathode) may continue to move to the right (FIG. 5) and combined with a separator film 16 delivered via rollers 18A and 18B from a separate solid-state electrolyte or separator production line (not shown). Cathode film 14 and separator film 16 are combined and consolidated by rollers 18B and 18C (as an example) to form a multi-layer structure, which is further combined and consolidated with an anode film 22 via rollers 24A, 24B, and 24C to form a laminate 26. Again, heat may be applied to melt the polymer during the consolidation procedure. This anode film 22 may be produced in a similar manner as the cathode film on a separate production line (not shown). The laminate 26 may be wound on a collector roller 28 and later cut and trimmed into desired shape and sizes to make a battery cell.

In certain embodiments, step (b) comprises dispensing and consolidating a plurality of the multi-functional composite particulates into an anode film on at least a surface (preferably two surfaces) of a second solid substrate to form an anode. Again, the anode film is preferably made by a roll-to-roll process as described above.

Several mass production processes may be used to produce an anode, cathode, and separator, not necessarily in the aforementioned roll-to-roll manner. These include, but are not limited to, compression molding, extrusion, casting, roll-pressing, and lamination.

In some embodiments, step (a) comprises (a-1) electrically charging the plurality of multi-functional composite particulates onto at least a surface of the first solid substrate and heating and compressing the composite particulates against the first solid substrate to form a cathode; or comprises (a-2) heating, extruding, and compressing the composite particulates into a cathode film which is supported on a surface of the first solid substrate.

In some preferred embodiments, step (b) comprises (b-1) electrically charging the plurality of multi-functional composite particulates onto at least a surface of the second solid substrate and heating and compressing the composite particulates against the second solid substrate to form an anode; or comprises (b-2) heating, extruding, and compressing the composite particulates into an anode film which is supported on a surface of the second solid substrate.

In some embodiments, step (c) of providing a separator comprises preparing a separator layer comprising (i) a polymer electrolyte comprising from 0.1% to 50% by weight of a lithium salt dissolved or dispersed in said polymer electrolyte, wherein said polymer electrolyte has a lithium ion conductivity from 10⁻⁸ to 5×10⁻² S/cm; and (ii) particles of an inorganic material having a diameter or thickness from 2 nm to 10 μm and occupying a weight fraction from 0% to 99% (preferably from 60% to 95%) based on the total weight of the separator layer.

In some preferred embodiments, step (c) of providing a separator comprises a sub-step (c-1) of preparing a plurality of composite particulates wherein at lease a composite particulate comprises (i) a polymer electrolyte comprising from 0.1% to 50% by weight of a lithium salt dissolved or dispersed in the polymer electrolyte having a lithium ion conductivity from 10⁻⁸ to 5×10⁻² S/cm; and (ii) particles of an inorganic material having a diameter or thickness from 2 nm to 10 μm and occupying a weight fraction from 0% to 99% (preferably from 60% to 95%) based on the total weight of the composite particulate; and a sub-step (c-2) of forming the plurality of composite particulates into a separator layer.

The disclosure further provides a method of producing the aforementioned battery, the method comprising (a) dispensing and consolidating a plurality of the multi-functional composite particulates into an anode film on at least a surface of a first solid substrate to form an anode; (b) providing a cathode; (c) providing a separator; and (d) combining or laminating the cathode, the separator, and the anode into a battery cell and optionally enclosing the cell in a protective housing.

The disclosure also provides a method of producing the disclosed multi-functional composite particulates, the method comprising (A) dispersing (i) a plurality of primary particles of an anode active material or cathode active material (having a diameter or thickness from 0.5 nm to 20 μm), (ii) a lithium salt, and (iii) particles of an inorganic solid electrolyte (having a diameter or thickness from 2 nm to 20 μm) in a liquid mixture of a monomer or oligomer, an initiator, and/or a cross-linking agent to form a reactive slurry; (B) forming the reactive slurry into micro-droplets and partially polymerizing and/or curing the monomer or oligomer in the micro-droplets to form the multi-functional particulates.

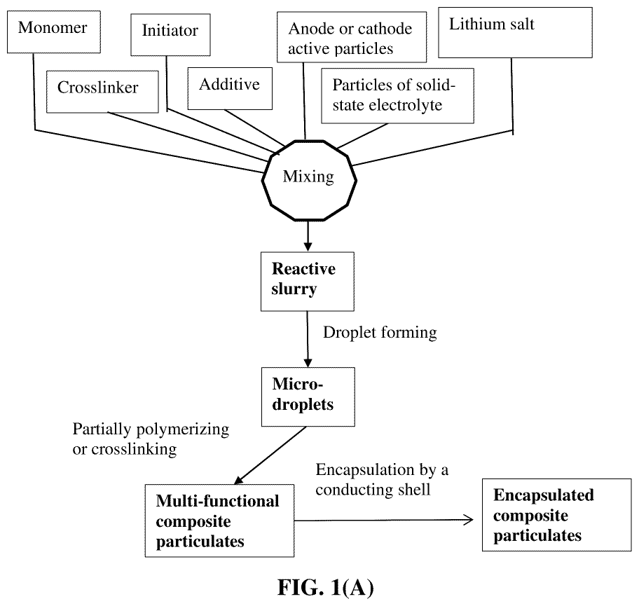

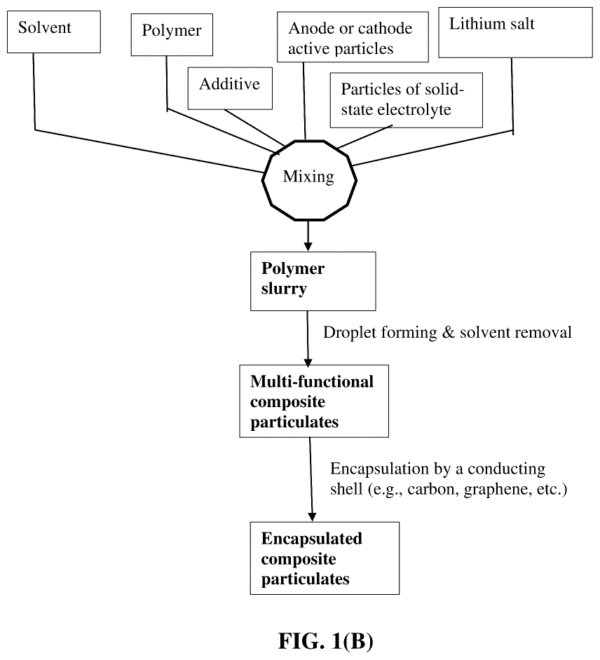

As schematically illustrated in FIG. 1(A), the method comprises mixing reactants (monomer, initiator, and optional curing or crosslinking agent), primary particles of an anode active material, optional reinforcement material, particles of inorganic solid electrolyte and an electron-conducting additive, to form a reactive slurry. One may mix these ingredients sequentially or concurrently. For instance, one may mix all of these ingredients to form the reactive slurry in one pot (one container) all at once and then form the reactive slurry into micro-droplets, allowing the reactants to react with one another for partially polymerizing and/or crosslinking to form the polymer chains. The anode or cathode active material particles, along with other ingredients, are dispersed in, embedded in, bonded by, or encapsulated by the electrolyte polymer.

Alternatively, one may first mix certain ingredient(s) in one pot and other ingredients in other pot(s) and then combine them together in one pot. For instance, one may mix the monomer and the initiator in one pot, allowing the mixture to proceed to form a reactive oligomer (low molecular weight chains). A separate pot may be used to contain the curing agent (crosslinker). The primary particles of anode active material and other ingredients may be dispersed into either pot or both pots. The ingredients in two pots are then combined together and then heated or radiation-exposed to initiate the polymerization and crosslinking reactions (if appropriate).

Also provided is a method of producing the multi-functional composite particulates, the method comprising (A) dispersing (i) a plurality of primary particles of an anode active material or cathode active material (having a diameter or thickness from 0.5 nm to 20 μm), (ii) a lithium salt, and (iii) particles of an inorganic solid electrolyte (having a diameter or thickness from 2 nm to 20 μm) in a polymer solution (containing a polymer dissolved in a liquid solvent) to form a slurry; (B) forming the slurry into micro-droplets and removing the liquid solvent in the micro-droplets to form the multi-functional particulates. In some embodiments, the reactive slurry further comprises a reinforcement material, an electron-conducting additive, or a combination thereof.

In certain embodiments, the multiple micro-droplets of electrolyte polymer-embedded anode active material particles are produced by operating a procedure selected from pan-coating, air-suspension coating, centrifugal extrusion, vibration-nozzle encapsulation, spray-drying, coacervation-phase separation, interfacial polycondensation and interfacial cross-linking, in-situ polymerization, matrix polymerization, extrusion and pelletizing, or a combination thereof.

Several micro-encapsulation processes require the polymer to be dissolvable in a solvent or its precursor (or monomer or oligomer) initially contains a liquid state (flowable). Fortunately, all the polymers or their precursors used herein are soluble in some common solvents or the monomer or other polymerizing/curing ingredients are in a liquid state to begin with.

There are three broad categories of micro-encapsulation methods that can be implemented to produce electrolyte polymer-embedded or encapsulated anode particles (the micro-droplets): physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization. In all of these methods, polymerization and/or crosslinking may be allowed to proceed during and/or after the micro-droplet formation procedure.

Pan-coating method: The pan coating process involves tumbling the anode or cathode active material primary particles (along with other ingredients, such as particles of inorganic solid electrolyte, electron-conducting additive, lithium salt, and reinforcement material) in a pan or a similar device while the matrix material (e.g. monomer/oligomer liquid or uncured polymer/solvent solution; possibly containing a lithium salt dispersed or dissolved therein) is applied slowly until a desired amount of matrix is attained.

Air-suspension coating method: In the air suspension coating process, the solid primary particles of anode or cathode active material (along with other ingredients) are dispersed into the supporting air stream in an encapsulating chamber. A controlled stream of a reactive precursor solution (e.g. polymer or its monomer or oligomer dissolved in a solvent; or its monomer or oligomer alone in a liquid state) is concurrently introduced into this chamber, allowing the solution to hit and coat/embed the suspended particles. These suspended particles are encapsulated by or embedded in the reactive precursor (monomer, oligomer, etc. which is polymerized/cured concurrently or subsequently) while the volatile solvent is removed, leaving behind a composite comprising a matrix of conducting polymer, electrode active material particles, and other ingredients. This process may be repeated several times until the required parameters, such as full-encapsulation, are achieved. The air stream which supports the anode particles also helps to dry them, and the rate of drying is directly proportional to the temperature of the air stream, which can be adjusted for optimized polymer network amount.

In a preferred mode, the particles in the encapsulating zone portion may be subjected to re-circulation for repeated coating. Preferably, the encapsulating chamber is arranged such that the particles pass upwards through the encapsulating zone, then are dispersed into slower moving air and sink back to the base of the encapsulating chamber, enabling repeated passes of the particles through the encapsulating zone until the desired encapsulating matrix amount is achieved.

Centrifugal extrusion: Primary anode particles (along with other ingredients) may be embedded in a polymer or precursor material using a rotating extrusion head containing concentric nozzles. In this process, a stream of core fluid (slurry containing electrode particles and other ingredients dispersed in a solvent) is surrounded by a sheath of shell solution or melt containing the polymer or precursor. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle encapsulation method: matrix-encapsulation of anode particles (along with other ingredients) can be conducted using a laminar flow through a nozzle and vibration of the nozzle or the liquid. The vibration has to be done in resonance with the Rayleigh instability, leading to very uniform droplets. The liquid can include any liquids with limited viscosities (1-50,000 mPa·s): emulsions, suspensions or slurry containing the anode active material particles and the polymer or precursor.

Spray-drying: Spray drying may be used to encapsulate electrode particles (along with other ingredients) when the particles are suspended in a melt or polymer/precursor solution to form a suspension. In spray drying, the liquid feed (solution or suspension) is atomized to form droplets which, upon contacts with hot gas, allow solvent to get vaporized and thin polymer shell or matrix to fully embrace the particles.

Coacervation-phase separation: This process includes three steps carried out under continuous agitation:
(a) Formation of three immiscible chemical phases: liquid manufacturing vehicle phase, core material phase and encapsulation material phase. The particles are dispersed in a solution of the encapsulating polymer or precursor. The encapsulating material phase, which is an immiscible polymer in liquid state, is formed by (i) changing temperature in polymer solution, (ii) addition of salt, (iii) addition of non-solvent, or (iv) addition of an incompatible polymer in the polymer solution.
(b) Deposition of encapsulation material: particles being dispersed in the encapsulating polymer solution, encapsulating polymer/precursor coated around particles, and deposition of liquid polymer embracing around particles by polymer adsorbed at the interface formed between core material and vehicle phase; and
(c) Hardening of encapsulating shell material: shell material being immiscible in vehicle phase and made rigid via thermal, cross-linking, or dissolution techniques.

Interfacial polycondensation and interfacial cross-linking: Interfacial polycondensation entails introducing the two reactants to meet at the interface where they react with each other. This is based on the concept of the Schotten-Baumann reaction between an acid chloride and a compound containing an active hydrogen atom (such as an amine or alcohol), polyester, polyurea, polyurethane, or urea-urethane condensation. Under proper conditions, thin flexible encapsulating shell (wall) forms rapidly at the interface. A suspension of the particles and a diacid chloride are emulsified in water and an aqueous solution containing an amine and a polyfunctional isocyanate is added. A base may be added to neutralize the acid formed during the reaction. Condensed polymer shells form instantaneously at the interface of the emulsion droplets. Interfacial cross-linking is derived from interfacial polycondensation, wherein cross-linking occurs between growing polymer chains and a multi-functional chemical groups to form a polymer shell material.

In-situ polymerization: In some micro-encapsulation processes, particles are fully embedded in a monomer or oligomer first. Then, direct polymerization of the monomer or oligomer is carried out with the presence of these material particles dispersed therein.

Matrix polymerization: This method involves dispersing and embedding electrode primary particles (along with other ingredients) in a polymeric matrix during formation of the particles. This can be accomplished via spray-drying, in which the particles are formed by evaporation of the solvent from the matrix material. Another possible route is the notion that the solidification of the matrix is caused by a chemical change.

The following examples serve to provide the best modes of practice for the present disclosure and should not be construed as limiting the scope of the disclosure:

### Example 1: Preparation of Inorganic Solid Electrolyte (ISE) Powder, Lithium Nitride Phosphate Compound (LIPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form. These ISE particles can be combined with a polymer to form hybrid solid-state electrolyte particulates for use in an anode, a cathode, and/or a separator.

### Example 2: Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting inorganic solid electrolyte material was then subjected to grinding in a mortar to form a powder sample to be later added as inorganic solid electrolyte particles encapsulated by an intended polymer electrolyte shell.

### Example 3: Preparation of Garnet-Type Inorganic Solid Electrolyte Powder

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃-9H₂O, La(NO₃)₃-6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was encapsulated in several ion-conducting polymers.

### Example 4: Preparation of Sodium Superionic Conductor (NASICON) Type Inorganic Solid Electrolyte Powder

The Na_{3.1}Zr_{1.95}M_{0.05}Si₂PO₁₂ (M=Mg, Ca, Sr, Ba) materials were synthesized by doping with alkaline earth ions at octahedral 6-coordination Zr sites. The procedure employed includes of two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C.

### Example 5: Production of Composite Particulates Comprising Poly(Vinylidene Fluoride)-Hexafluoropropylene (PVDF-HFP) as a Polymer Electrolyte Matrix

PVDF-HFP is dissolvable in a liquid solvent such as N,N′-dimethylformamide (DMF), N-methylpyrrolidone (NMP), dimethyl sulfoxide (DMSO), and acetone. We chose to use a mixture of DMSO and acetone (1/1 volume ratio) to dissolve a lithium salt (LiPF₆) up to a mole ratio of 0.8 at 45° C. and to dissolve PVDF-HFP up to 3% by weight to obtain a polymer solution. Then, 15% by weight (relative to the intended total composite weight) of nano particles of an inorganic solid-state electrolyte (LGPS prepared in Example 2), 2% by weight of carbon nanotubes (CNTs), 1% reduced graphene oxide sheets (from Angstron Materials, Inc.), and 82% by weight of lithium iron phosphate (LFP) particles were dispersed in the polymer solution to obtain a slurry having a solid content of 10% by weight. The slurry was sprayed and cast onto a glass substrate and dried in a vacuum oven at 65° C. overnight to obtain dried powder of composite particulates.

A sample of these composite particulates was placed in a compression-molding mold cavity preset at 180° C., compressed at a pressure of 15 psi, and cooled down to room temperature to make a cathode supported by an Al foil.

An anode supported on a Cu foil was prepared in a similar manner, but the LFP particles were replaced by graphene-protected Si anode particles (from Honeycomb Battery Co., Dayton, Ohio). Further, a separator was prepared in a similar manner, but no electrode active material and no electron-conducting additive were included. The cathode, the separator, and the anode were then stacked and heated to 180° C. for 5 minutes under a pressure of 20 psi and subsequently cooled to room temperature to prepare a battery cell. The anode, the separator, and the cathode have the same PVDF-HFP-based polymer electrolyte.

### Example 6: Production of Poly(Acrylonitrile)-Based Composite Particulates for an NCM-622 Cathode

Poly(acrylonitrile) (PAN) is soluble in polar solvents, such as dimethylformamide (DMF), dimethylacetamide (DMAc), ethylene carbonate (EC) and propylene carbonate (PC), and in aqueous solutions of sodium thiocyanate, zinc chloride or nitric acid. The present study primarily made use of DMAc and EC as a solvent. A lithium salt (LiPF₆) was dissolved in EC for up to a mole ratio of 1.2 at 45° C. On a separate basis, 5% by weight of PAN was dissolved in EC to make a polymer solution. The EC/LiPF₆ solution was then mixed with the EC/PAN solution to form a mixture solution. Nano particles of SiO₂ and LLZO, along with cathode active material particles (NCM-622) and graphene sheets, were then dispersed in the mixture solution to obtain a slurry having a solid content of 4.5%. The amounts of particles and additives were added for the purpose of reaching the following weight %: SiO₂ (8%), LLZO (10%), graphene sheets (2%), and NCM-622 (80%) in the polymer composite. The slurry was spray-dried to form composite particles, which were used as a building block for a cathode.

### Example 7: Preparation of Composite Particulates Comprising Pentaerythritol Tetraacrylate (PETEA)-Based Electrolyte Polymer

Several types of anode active materials in a fine powder form were investigated. These include Si and SiOₓ (x≈1), which are used as examples to illustrate the best mode of practice. These active materials were either prepared in house or purchased from commercial sources.

A pentaerythritol tetraacrylate (PETEA)-based electrolyte polymer was prepared by gelation of a precursor solution. The precursor solution comprising 1.5 wt % PETEA (C₁₇H₂₀O₈) as a monomer and 0.01 wt. % azobisdiisobutyronitrile (AIBN,C₈H₁₂N₄) as an initiator dissolved in a liquid electrolyte containing 1M bis(trifluoromethane) sulfonamide lithium (LiTFSI) salt in a mixture of 1,2-dioxolane (DOL)/dimethoxymethane (DME) (1:1 by volume). A powder mass of anode active material particles (85%), acetylene black particles (8%), nano particles of LIPON-type solid-state electrolyte (5%) prepared in Example 1, and the precursor solution were combined to form micro-droplets via pan-coating. The precursor solution in the micro-droplets was polymerized at 60° C. for 20 minutes to obtain composite particulates containing incompletely cured resin.

The radical polymerization of PETEA was thermally initiated by azobisisobutyronitrile (AIBN). The polymerization reaction occurs in liquid electrolyte. The primary radicals derived via the thermal decomposition of AIBN attack the C═C double bond of the PETEA monomer to create four free radicals on the monomer since PETEA possesses four C═C double bonds to be initiated, followed by the chain growth reaction by sequentially adding PETEA monomers to the active sites (i.e., four free radical ends) of initiated monomer.

Separately, a cathode was similarly prepared by replacing the anode active material with a cathode active material, NCM-811 particles.

A separator layer was prepared in a similar manner except for the notion that there were no acetylene black and no anode particles and that the nano particles of LIPON occupied 93% by weight. The lithium salt-containing polymer proportion was 7%.

A Cu foil, the anode layer, the separator layer, the cathode layer, and an Al foil were assembled and compression-molded together at 85° C. for 3 hours. A majority of the solvent was squeezed out and vaporized while the resin mass formed a three-dimensional network-like polymerized PETEA. The same polymer was used throughout the anode layer, separator, and cathode layer, eliminating the high interfacial resistance problem commonly associated with the conventional inorganic solid electrolyte-based battery.

### Example 8: Composite Particulates Containing Cyanoethyl Poly(Vinyl Alcohol) (PVA-CN) as a Polymer Matrix

The procedures for producing electrolyte polymer-embraced composite particulates were similar to those in Example 7. Cyanoethyl poly(vinyl alcohol) polymer was prepared by gelation of a precursor solution containing 2 wt. % PVA-CN dissolved in a liquid electrolyte that contained 1M LiPF₆ in a mixture solution of ethylene carbonate (EC)/dimethyl carbonate (DMC)/ethylmethyl carbonate (EMC) with a volume ratio of 1:1:1. The Si nanowires, Sn, SiOₓ, SnO₂, and Ge primary particles were separately combined with a reacting precursor solution, along with NASICON-type inorganic solid electrolyte powder and multi-walled carbon nanotubes (as an electron-conducting additive), to form reactive micro-droplets using pan-coating. In one sample, these composite droplets were then combined and consolidated into an anode film. The precursor solution in the film was heated at a temperature of 70° C. to obtain PVA-CN based composite anodes.

### Example 9: Production of Poly(Vinyl Carbonate)-Based Composite Particulates

Liquid vinylene carbonate (VC), in the presence of a lithium salt, can be polymerized into poly(vinyl carbonate) (PVCA) catalyzed by a thermally initialized radical initiator. The lithium salt, lithium difluoro (oxalate) borate (LiDFOB) has the combined chemical structures of lithium bis(oxalate) borate and lithium tetrafluoroborate (LiBF₄). In an experiment, 1.43 g LiDFOB was dissolved in to 10 mL VC to obtain a homogeneous and transparent solution (1.0 m LiDFOB in VC. ˜ 9.6% (w/w)) and then the solution was added with 10 mg AIBN. Desired amounts of anode active particles (Si), Li₁₀GeP₂S₁₂ (LGPS)-type nano-particles, and carbon nanotubes were then combined with this solution using a pan-coating procedure to produce reactive composite micro-droplets. The droplets were formed into a film on a Cu foil and maintained at 60° C. for 2 h in a vacuum oven to advance the polymerization of VC to an extent that the particulates were no longer flow like a liquid.

In a similar manner, a layer of consolidated NCM-622-based cathode was formed on an Al foil surface, all other ingredients remaining unchanged. A separator layer was prepared from 85% by weight of LGPS-type nano-particles and the same lithium salt-containing reactive VC solution. The anode, the separator and the cathode were laminated together and heated at 80° C. for 20 hours under a light pressure to form a battery cell.

### Examples 10: Crosslinked Polymer Electrolyte (LiBAMB-PETMP Single Ion-Conducting Polymer Electrolyte)-Embedded Composite Particulates

The experiment began with the synthesis of lithium bis(allylmalonato)borate (LiBAMB). In a representative procedure, allylmalonic acid (60 mmol), lithium carbonate (15 mmol) and boric acid (30 mmol) were added in 150 mL dry acetonitrile to form a solution. The solution was heated under nitrogen gas flow in an oil bath at 80° C. for 12 h. After cooling down, the solution mass was filtered and the solvent was removed under reduced pressure. A white solid was obtained after drying in a vacuum oven at 60° C. for 48 h.

Subsequently, the LiBAMB-PETMP single lithium ion-conducting polymer electrolyte was synthesized from pentaerythritol tetrakis(2-mercaptoacetate) (PETMP) and LiBAMA. In an argon filled glove box, LiBAMB (2.5 mmol), PETMP (1.25 mmol) and 2,2-dimethoxy-2-phenylacetophenone (DMPA, 0.25 mmol) were dissolved in 5 mL gamma-butyrolactone (GBL) to form a reactive solution. A desired amount (83%) of Si nano particles (as an example of an anode active material), garnet-type solid electrolyte particles (5%), and some conducting fillers (5% of graphene sheets and carbon black), all based on the final composite particulate weight, were dispersed in the reactive solution to form a reactive slurry, which was quickly spray-dried to form reactive composite micro-droplets. The micro-droplets were then exposed to UV light (365 nm) for 20 min and then consolidated together to form an anode film on a Cu foil. The film was further exposed to UV light at 80° C. for 1 hour to complete the reaction.

### Example 11: Preparation of Composite Particulates Based on Another Single Ion-Conducting Polymer Electrolyte

Another single-ion conducting polymer electrolyte (SIPE) with a high lithium-ion transference number, good mechanical strength, and excellent ionic conductivity was synthesized by coupling of lithium bis(allylmalonato) borate (LiBAMB), pentaerythritol tetrakis(2-mercaptoacetate) (PETMP) and 3,6-dioxa-1,8-octanedithiol (DODT), in a the presence of cathode active material particles, LLZO particles and CNTs, via a one-step photo-initiated in situ thiol-ene click reaction. The structure-optimized LiBAMB-PETMP-DODT material shows an outstanding ionic conductivity of 1.32× 10-3 S/cm at 25° C., together with a high lithium-ion transference number of 0.92 and wide electrochemical window up to 6.0 V.

The SIPE-embraced composite particulates were prepared by a method that included immersing all solid particles into the precursor solution, including LiBAMB, PETMP, and DODT. After thorough mixing, the curing agent (DMTA) was added into the precursor solution and the resulting slurry was spray-dried to form reactive micro-droplets. Then, the procedure further included forming the micro-droplets into a film and exposing a cast film containing the micro-droplets to ultraviolet (UV) light (365 nm). Photo-initiated in situ thiol-ene click reaction took place immediately and was completed in less than 5 minutes.

1. Multi-functional composite particulates for a lithium battery, wherein at least one of said composite particulates has a diameter from 100 nm to 50 μm and comprises (a) a polymer electrolyte, comprising from 0% to 50% by weight of a lithium salt dissolved or dispersed in said polymer electrolyte; (b) a plurality of primary particles of an anode or cathode active material that are embedded or dispersed in or bonded by said polymer electrolyte, wherein said polymer electrolyte has a lithium ion conductivity from 10⁻⁸ to 5×10⁻² S/cm and wherein said active material primary particles have a diameter or thickness from 1 nm to 20 μm and occupy a weight fraction from 5% to 98% based on the total weight of the composite particulate; (c) particles of an inorganic material having a diameter or thickness from 2 nm to 20 μm and occupying a weight fraction from 0% to 30% based on the total weight of the composite particulate; and (d) an electron-conducting additive having a weight fraction of 0% to 30% based on the total weight of the composite particulate.

2. Multi-functional composite particulates for a lithium battery, wherein at least one of said composite particulates has a diameter from 100 nm to 50 μm and comprises (A) a polymer electrolyte, comprising from 0.1% to 50% by weight of a lithium salt dissolved or dispersed in said polymer electrolyte having a lithium ion conductivity from 10⁻⁸ to 5×10⁻² S/cm; and (B) particles of an inorganic material having a diameter or thickness from 2 nm to 10 μm and occupying a weight fraction from 1% to 98% based on the total weight of the composite particulate.

3. The multi-functional composite particulates of claim 1, wherein said polymer electrolyte comprises a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a semi-penetrating network thereof, a sulfonated derivative thereof, or a combination thereof.

4. The multi-functional composite particulates of claim 1, wherein said lithium salt is selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃ (CF₂CF₃)₃, lithium bisperfluoro-ethysulfonylimide, LiBETI, lithium trifluoromethanesulfonimide, LiTFSI, an ionic liquid-based lithium salt, or a combination thereof.

5. The multi-functional composite particulates of claim 1, wherein said polymer electrolyte is further impregnated with an organic liquid solvent, an ionic liquid, or a combination thereof.

6. The multi-functional composite particulates of claim 1, wherein said polymer electrolyte comprises (i) a polymer that is meltable by heat or soluble by a liquid solvent; or (ii) a precursor, comprising a monomer with an initiator and/or a cross-linking agent, an oligomer, or a growing chain that is polymerizable, cross-linkable, partially polymerized, or partially cross-linked.

7. The multi-functional composite particulates of claim 1, wherein said composite particulate is further encapsulated by a shell of conducting material selected from graphene, carbon, graphite, metal, conductive composite, or a combination thereof, wherein said shell has an electrical conductivity from 10⁻⁸ S/cm to 10³ S/cm and a thickness from 0.34 nm to 10 μm.

8. The multi-functional composite particulates of claim 1, wherein said composite particulate further comprises graphene sheets dispersed in said polymer electrolyte matrix and said graphene sheets are selected from pristine graphene, graphene fluoride, graphene chloride, graphene bromide, graphene iodide, nitrogenated graphene, hydrogenated graphene, doped graphene, chemically functionalized graphene, a combination thereof, or a combination thereof with graphene oxide or reduced graphene oxide.

9. The multi-functional composite particulates of claim 1, wherein said conductive additive is selected from carbon nanotubes, carbon nano-fibers, carbon or graphite fibers, graphene sheets, expanded graphite flakes, metal filaments or metal nano-wires, whiskers, carbon black, acetylene black, needle coke, carbon particles, graphite particles, a combination thereof, or a combination thereof with an electrically conductive polymer.

10. The multi-functional composite particulates of claim 1, wherein said anode active material is selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide; (f) prelithiated versions thereof; (g) particles of Li, Li alloy, or surface-stabilized Li having at least 60% by weight of lithium element therein; and (h) combinations thereof.

11. The multi-functional composite particulates of claim 10, wherein said Li alloy contains from 0.1% to 10% by weight of a metal element selected from Zn, Ag, Au, Mg, Ni, Ti, Fe, Co, V, Al, or a combination.

12. The multi-functional composite particulates of claim 1, wherein said anode active material contains a prelithiated Si, prelithiated Ge, prelithiated Sn, prelithiated SnOₓ, prelithiated SiOₓ, prelithiated iron oxide, prelithiated Mn₃O₄, prelithiated Co₃O₄, prelithiated Ni₃O₄, lithium titanate, lithium niobite, or a combination thereof, wherein x=1 to 2.

13. The multi-functional composite particulates of claim 1, wherein said cathode active material is selected from an inorganic material, an organic material, a polymeric material, or a combination thereof.

14. The multi-functional composite particulates of claim 13, wherein said inorganic material, as a cathode active material, is selected from sulfur, selenium, a metal oxide, metal phosphate, metal silicide, metal selenide, metal sulfide, or a combination thereof.

15. The multi-functional composite particulates of claim 13, wherein said inorganic material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

16. The multi-functional composite particulates of claim 13, wherein said inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

17. The multi-functional composite particulates of claim 14, wherein said metal oxide or metal phosphate is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

18. The multi-functional composite particulates of claim 13, wherein the cathode active material comprises lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

19. The multi-functional composite particulates of claim 1, wherein said primary particles of anode or cathode active material are in a form of nano particle, nano wire, nano fiber, nano tube, nano sheet, nano belt, nano ribbon, nano disc, nano platelet, or nano horn having a thickness or diameter from 0.5 nm to 100 nm.

20. The multi-functional composite particulates of claim 1, wherein at least one of said primary anode or cathode active material particles is coated with a layer of carbon, graphite, or graphene.

21. The multi-functional composite particulates of claim 1, wherein said particles of inorganic material comprises particles of an inorganic solid electrolyte material selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

22. The multi-functional composite particulates of claim 1, wherein said particles of inorganic material is selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

23. A powder mass comprising the multi-functional composite particulates of claim 1, wherein the particulates comprise primary particles of an anode active material.

24. A powder mass comprising the multi-functional composite particulates of claim 1, wherein the particulates comprise primary particles of a cathode active material.

25. A powder mass comprising the multi-functional composite particulates of claim 2.

26. A battery anode or negative electrode that comprises the multi-functional composite particulates of claim 1 as an anode material or is made from the multi-functional composite particulates.

27. A battery cathode or positive electrode that comprises the multi-functional composite particulates of claim 1 as a cathode material or is made from the multi-functional composite particulates.

28. A battery comprising the multi-functional composite particulates of claim 1 as an anode material or a cathode material, wherein the battery is a lithium-ion battery, lithium metal battery, lithium-sulfur battery, lithium-air battery, or lithium-selenium battery.

29. A method of producing the battery of claim 28, the method comprising (a) dispensing and consolidating a plurality of the multi-functional composite particulates into a cathode film on at least a surface of a first solid substrate to form a cathode (positive electrode); (b) providing an anode (negative electrode); (c) providing a separator; and (d) combining or laminating the cathode, the separator, and the anode into a battery cell and enclosing the cell in a protective housing.

30. The method of claim 29, wherein step (b) comprises dispensing and consolidating a plurality of the multi-functional composite particulates into an anode film on at least a surface of a second solid substrate to form an anode.

31. The method of claim 29, wherein step (a) comprises (a-1) electrically charging and dispensing the plurality of multi-functional composite particulates onto at least a surface of the first solid substrate and heating and compressing the composite particulates against the first solid substrate to form a cathode; or comprises (a-2) heating, extruding, and compressing the composite particulates into a cathode film which is supported on a surface of the first solid substrate.

32. The method of claim 30, wherein step (b) comprises (b-1) electrically charging and dispensing the plurality of multi-functional composite particulates onto at least a surface of the second solid substrate and heating and compressing the composite particulates against the second solid substrate to form an anode; or comprises (b-2) heating, extruding, and compressing the composite particulates into an anode film which is supported on a surface of the second solid substrate.

33. A method of producing the battery of claim 29, comprising (a) dispensing and consolidating a plurality of the multi-functional composite particulates into an anode film on at least a surface of a first solid substrate to form an anode; (b) providing a cathode; (c) providing a separator; and (d) combining or laminating the cathode, the separator, and the anode into a battery cell and enclosing the cell in a protective housing.

34. The method of claim 29, wherein step (c) of providing the separator includes preparing a separator layer comprising (i) a polymer electrolyte comprising from 0.1% to 50% by weight of a lithium salt dissolved or dispersed in said polymer electrolyte, wherein said polymer electrolyte has a lithium ion conductivity from 10⁻⁸ to 5×10⁻² S/cm; and (ii) particles of an inorganic material having a diameter or thickness from 2 nm to 10 μm and occupying a weight fraction from 0% to 99% based on the total weight of the separator layer.

35. The method of claim 29, wherein step (c) of providing a separator comprises a sub-step (c-1) of preparing a plurality of composite particulates wherein at least one composite particulate comprises (i) a polymer electrolyte comprising from 0.1% to 50% by weight of a lithium salt dissolved or dispersed in said polymer electrolyte having a lithium ion conductivity from 10⁻⁸ to 5×10⁻² S/cm; and (ii) particles of an inorganic material having a diameter or thickness from 2 nm to 10 μm and occupying a weight fraction from 0% to 99% based on the total weight of the composite particulate; and a sub-step (c-2) of forming said plurality of composite particulates into a separator layer.

36. The method of claim 29, wherein the anode, the separator, or both the anode and the separator comprise a polymer electrolyte that is substantially the same type of polymer as in the cathode.

37. A method of producing the multi-functional composite particulates of claim 1, comprising (A) dispersing (i) a plurality of primary particles of an anode active material or cathode active material, having a diameter or thickness from 0.5 nm to 20 μm, (ii) a lithium salt, and (iii) particles of an inorganic solid electrolyte, having a diameter or thickness from 2 nm to 20 μm, in a liquid mixture of a monomer or oligomer, an initiator, and/or a cross-linking agent to form a reactive slurry; (B) forming the reactive slurry into micro-droplets and partially polymerizing and/or curing the monomer or oligomer in said micro-droplets to form the multi-functional particulates.

38. A method of producing the multi-functional composite particulates of claim 1, comprising (A) dispersing (i) a plurality of primary particles of an anode active material or cathode active material, having a diameter or thickness from 0.5 nm to 20 μm, (ii) a lithium salt, and (iii) particles of an inorganic solid electrolyte, having a diameter or thickness from 2 nm to 20 μm, in a liquid solution of a polymer dissolved in a solvent to form a slurry; (B) forming the slurry into micro-droplets and removing the liquid solvent in said micro-droplets to form the multi-functional particulates.

39. The method of claim 37, wherein said reactive slurry further comprises a reinforcement material, an electron-conducting additive, or a combination thereof.

40. The method of claim 37, wherein said step (B) of forming micro-droplets comprises a procedure selected from pan-coating, air-suspension coating, centrifugal extrusion, vibration-nozzle encapsulation, spray-drying, coacervation-phase separation, interfacial polycondensation or interfacial cross-linking, in-situ polymerization, matrix polymerization, extrusion and palletization, or a combination thereof.

41. The method of claim 39, wherein said reinforcement material or ion-conducting additive is selected from carbon nanotubes, carbon nano-fibers, carbon or graphite fibers, graphene sheets, expanded graphite flakes, carbon black, acetylene black, polymer fibrils, glass fibers, ceramic fibers, metal filaments, metal nano-wires, or a combination thereof.
